(19) United States
(12) Patent Application Publication
(10) Pub. No.: US 2024/0042693 A1
(43) Pub. Date: Feb. 8, 2024

(54) 3D Printer Feeding Module

(71) Applicant: Ibossen R&D (Shenzhen) Co., Ltd., Shenzhen (CN)

(72) Inventor: Huihui Fan, Heyuan (CN)

(21) Appl. No.: 17/878,950

(22) Filed: Aug. 2, 2022

(51) Int. Cl. B29C 64/321; B33Y 40/00

(52) U.S. Cl. CPC B29C 64/321; B33Y 40/00

(57) ABSTRACT

A 3D printer feeding module comprises a base and an upper cover. An inward integrally-formed convex portion is arranged in the middle portion of upper cover and provided with a feeding channel for penetration of wires. A movable frame and two first rotating shafts are arranged between the base and upper cover and on both sides of the feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of the movable frame. A second drive gear and a second feeding roller which rotate synchronously are arranged on each second rotating shaft from bottom to top. A motor is arranged in the lower portion of base. A drive wheel is arranged at the shaft end of motor and meshed with two input gears; The feeding module delivers wires through two groups of first feeding rollers and second feeding rollers, with large and stable delivering force and suitable for delivering different sizes of wires.

### TECHNICAL FIELD

The invention relates to a 3D printer feeding module.

### BACKGROUND TECHNOLOGY

Three-dimensional printer, also called 3D printer, is a rapid-prototyping printing device which can print 3D objects with bonding materials such as special wax printing wire based on digital model files. When printing an object, the feeding module of 3D printer delivers wires to the delivering pipe connected between the printing head and feeding module, and the wires enter the printing head and are extruded into finished product after fusion. The feeding module of current 3D printer delivers wires through a drive wheel which drives a pairs of feeding rollers to rotate reversely, which is small in delivering force, leads to different sections in different positions of same wire bundle, poor feeding continuity and stability during rotation of feeding rollers are poor and may affect the printing precision and efficiency of object.

### INVENTION CONTENT

To overcome the shortcomings of prior arts, the invention provides a 3D printer feeding module.

To achieve the above purposes, the 3D printer feeding module in this invention comprises a module seat with an inner cavity, a feeding mechanism arranged in the cavity of module seat and an adjusting part for adjusting the feeding spacing of feeding mechanism;

The module seat comprises a base and an upper cover detachably connected on the upper portion of base. An inward integrally-formed convex portion is arranged in the middle portion of upper cover and provided with a feeding channel for penetration of wires. The base and the upper cover are provided with a feeding guide sleeve at the feeding end of feeding channel and a conical discharge port at the discharge end of feeding channel;

The feeding mechanism comprises a movable frame and two first rotating shafts which are arranged on both sides of a feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on each second rotating shaft from bottom to top. The second drive gear is meshed with the first drive gear due to the action of compression spring. The first feeding roller and the second feeding roller compress on both sides of wires. Both ends of first rotating shafts and second rotating shafts are provided with bearing;

An inward integrally-formed guiding portion is arranged on the lower surface of base. A guide groove matched with the guiding portion is formed in the bottom of movable frame. An extension plate which moves synchronously is also arranged on the movable frame. An adjusting part is embedded on one side of module seat, form a rotating structure with the base and upper cover through a rotating shaft portion, abuts against the extension plate through an extruding portion and provided with a folding portion at the end far away from the extruding portion.

As a further improvement, a motor is arranged in the lower portion of module seat. A drive wheel is arranged at the shaft end of motor and meshed with two input gears;

In the above technical scheme, the motor drives the rotation of two input gears.

As a further improvement, knurling is machined on the circumferences of first feeding roller and second feeding roller;

In the above technical scheme, the knurling increases friction force and can facilitate the delivery of wires.

As a further improvement, the upper cover is also provided with a detachable transparent cover;

In the above technical scheme, the upper cover is provided with a detachable transparent cover which is convenient for observing the cleanliness of module seat. The module seat can be cleaned timely after opening the transparent cover, so as to ensure the cleanliness gear drive structure.

To achieve the above purposes, the invention provides a 3D printer feeding module which comprises a module seat with an inner cavity, a feeding mechanism arranged in the cavity of module seat and an adjusting part for adjusting the feeding spacing of feeding mechanism;

The module seat comprises a base and an upper cover detachably connected on the upper portion of base. An inward integrally-formed convex portion is arranged in the middle portion of upper cover and provided with a feeding channel for penetration of wires;

The feeding mechanism comprises a movable frame and two first rotating shafts which are arranged on both sides of a feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on each second rotating shaft from bottom to top. The second drive gear is meshed with the first drive gear due to the action of compression spring. The first feeding roller and the second feeding roller compress on both sides of wires. Both ends of first rotating shafts and second rotating shafts are provided with bearing;

An inward integrally-formed guiding portion is arranged on the lower surface of base. A guide groove matched with the guiding portion is formed in the bottom of movable frame. An extension plate which moves synchronously is also arranged on the movable frame. An adjusting part is embedded on one side of module seat, form a rotating structure with the base and upper cover through a rotating shaft portion, abuts against the extension plate through an extruding portion and provided with a folding portion at the end far away from the extruding portion.

To achieve the above purposes, the invention provides a 3D printer feeding module which comprises a module seat with an inner cavity, a feeding mechanism arranged in the cavity of module seat and an adjusting part for adjusting the feeding spacing of feeding mechanism;

The module seat comprises a base and an upper cover detachably connected on the upper portion of base. An inward integrally-formed convex portion is arranged in the middle portion of upper cover and provided with a feeding channel for penetration of wires;

The feeding mechanism comprises a movable frame and two first rotating shafts which are arranged on both sides of a feeding channel. The first rotating shafts are arranged one behind the other in the feeding direction of feeding channel. An input gear, a first driver gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on each second rotating shaft from bottom to top. The second drive gear is meshed with the first drive gear. The first feeding roller and the second feeding roller compress on both sides of wires. Both ends of first rotating shafts and second rotating shafts are provided with bearing.

Compared with the prior air, the invention has the following advantageous effect: The feeding module delivers wires through two groups of first feeding rollers and second feeding rollers, which is large and stable in delivering force. Due to the action of compression spring, the second feeding roller abuts against the exterior of wires elastically, which is suitable for delivering different sizes of wires. When delivering same wire bundle, a small section difference is permitted, which can ensure the delivery continuity and stability. An adjusting part for adjusting the spacing between the first feeding roller and the second feeding roller is convenient for wire feeding and internal cleaning of module seat to some extent.

### DESCRIPTION OF FIGURES

FIG. 1 is the stereogram of 3D printer feeding module;

FIG. 2 is the diagram of upper cover;

FIG. 3 is the diagram of FIG. 1 after the upper cover is hidden;

FIG. 4 is the explosive view of 3D printer feeding module;

FIG. 5 is the diagram of movable frame.

In the figure: 1. Motor; 2. Base; 21. Guiding portion; 3. Upper cover; 31. Convex portion; 311. Feeding channel; 32. Transparent cover; 4. Wires; 5. Adjusting part; 51. Rotating shaft portion; 52. Extruding portion; 53. Folding portion; 6. Compression spring; 7. Movable frame; 71. Guiding groove; 72. Extension plate; 8. Second rotating shaft; 9. First rotating shaft; 10. Second feeding roller; 11. Second drive gear; 12. First feeding roller; 13. First drive gear 14. Input gear; 15. Drive wheel; a. Feeding guide sleeve; b. Discharge port.

### SPECIFIC IMPLEMENTATION MODE

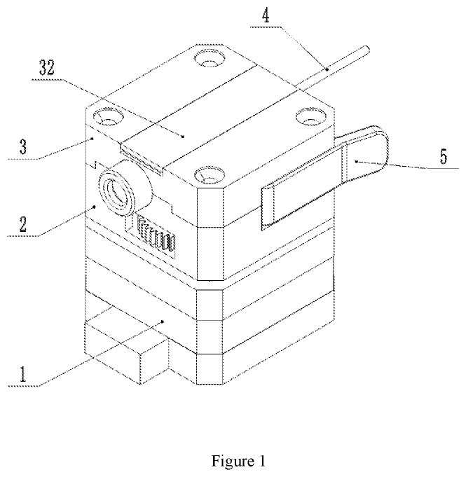

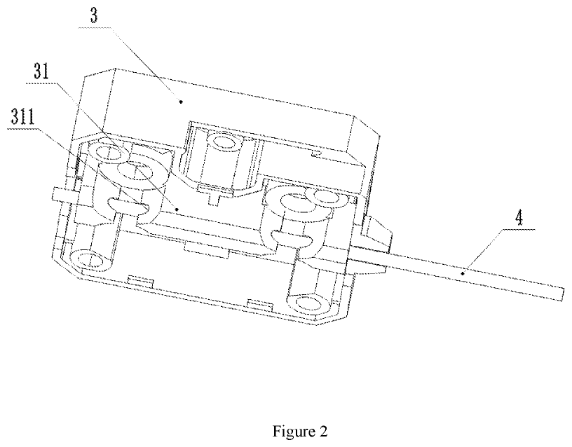

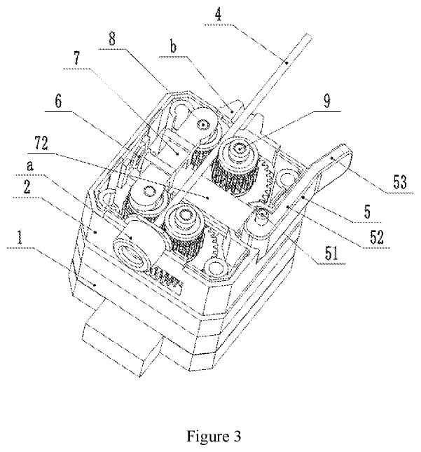

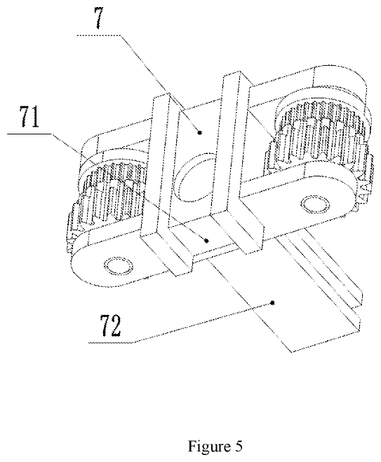

As shown in FIG. 1 to FIG. 5, the 3D printer feeding module comprises a module seat with an inner cavity, a feeding mechanism arranged in the cavity of module seat and an adjusting part 5 for adjusting the feeding spacing of feeding mechanism; The module seat comprises a base 2 and an upper cover detachably connected on the upper portion of base 2. An inward integrally-formed convex portion 31 is arranged in the middle portion of upper cover 3 and provided with a feeding channel 311 for penetration of wires 4. The base 2 and the upper cover 3 are provided with a feeding guide sleeve at the feeding end of feeding channel 311 and a discharge port b at the discharge end of feeding channel 311; The feeding mechanism comprises a movable frame 7 and two first rotating shafts 9 which are arranged on both sides of a feeding channel 311. The first rotating shafts are arranged one behind the other in the feeding direction of feeding channel 311. An input gear 14, a first drive gear 13 and a first feeding roller 12 which rotate synchronously are arranged on first rotating shafts 9 from bottom to top. The movable frame 7 is connected with the base 2 through a compression spring 6. Second rotating shafts 8 are arranged at both ends of movable frame 7. A second drive gear 11 and a second feeding roller 10 which rotate synchronously are arranged on each second rotating shaft 8 from bottom to top. The second drive gear 11 is meshed with the first drive gear 13 due to the action of compression spring 6. The first feeding roller 12 and the second feeding roller 10 compress on both sides of wires 4. Both ends of first rotating shafts 9 and second rotating shaft 8 are provided with bearing; An inward integrally-formed guiding portion 21 is arranged on the lower surface of base 2. A guiding groove 71 matched with the guiding portion 21 is formed in the bottom of movable frame 7. An extension plate 72 which moves synchronously is also arranged on the movable frame 7. An adjusting part 5 is embedded on one side of module seat, constitute a rotating structure with the base 2 and upper cover 3 through a rotating shaft portion 51, abuts against the extension plate 72 through an extruding portion 52 and provided with a folding portion 53 at the end far away from the extruding portion 52; A motor 1 is arranged in the lower portion of module seat. A drive wheel 15 is arranged at the shaft end of motor 1 and meshed with two input gears 14. The motor drives the rotation of two input gears; The upper cover 3 is also provided with a detachable transparent cover 32 which is convenient for observing the cleanliness of module seat. The module seat can be cleaned timely after opening the transparent cover, so as to ensure the cleanliness of gear drive structure.

The feeding module delivers wires through two groups of first feeding rollers and second feeding rollers, which is large and stable in delivering force. Due to the action of compression spring, the second feeding roller abuts against the exterior of wires elastically, which is suitable for delivering different sizes of wires. When delivering same wire bundle, a small section difference is permitted, which can ensure the delivery continuity and stability. An adjusting part for adjusting the spacing between the first feeding roller and the second feeding roller is convenient for wire feeding and internal cleaning of module seat to some extent.

For better understanding the invention, figures are used to describe actual use conditions;

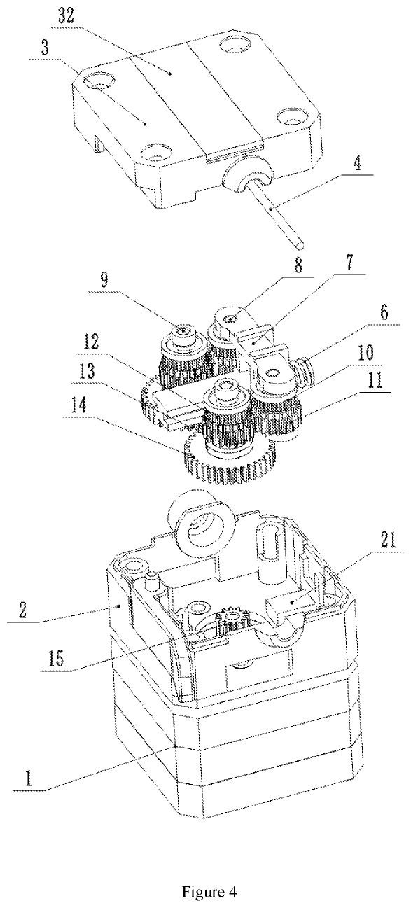

See FIG. 4, the motor 1 drives the drive wheel 15 so that the two input gears 14 are driven to rotate. The first rotating shaft 9 rotates synchronously with the input gears 14. The first drive gear 13 and the first feeding roller 12 rotate synchronously with the first rotating shafts 9. The first drive gear 13 and the second drive gear 11 drive the second rotating shafts 8 to rotate. The second feeding roller 10 rotates synchronously with the second rotating shafts 8. The first feeding roller 12 and the second feeding roller 10 rotate reversely and synchronously to deliver the wires 4 out.

The above content is only a preferred embodiment but not limited to this invention. For the technicians in this field, the invention may have various changes. All the modifications, substitutions or improvements shall be included in the protection scope based on the spirit and principle of invention.

1. A 3D printer feeding module is characterized by: A module seat with an inner cavity, a feeding mechanism arranged in the cavity of module seat and an adjusting part for adjusting the feeding spacing of feeding mechanism;
The module seat comprises a base and an upper cover which is detachably connected on the base. An inward integrally-formed convex portion is arranged in the middle portion of upper cover and provided with a feeding channel for penetration of wires. The base and upper cover are provided with a feeding guide sleeve at the feeding end of feeding channel and a conical discharge port at the discharge end of feeding channel;
The feeding mechanism comprises a movable frame and two first rotating shafts which are arranged besides the feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on each second rotating shaft from bottom to top. The second drive gear is meshed with the first drive gear due to the action of compression spring. The first feeding rollers and the second feeding rollers compress on both sides of wires. Both ends of first rotating shafts and second rotating shafts are provided with bearing;
An inward integrally-formed guiding portion is arranged on the lower surface of base. A guiding groove matched with the guiding portion is formed in the bottom of movable frame. An extension plate which moves synchronously is also arranged on the movable frame. An adjusting part is embedded on one side of module seat, form a rotating structure with the base and the upper cover through a rotating shaft portion, abuts against the extension plate through an extruding portion and provided with a folding portion at the end far away from the extruding portion.

2. As described in claim 1, the 3D printer feeding module is characterized in that: A motor is arranged in the lower portion of module seat. A drive wheel is arranged at the shaft end of motor and meshed with two input gears

3. As described in claim 1, the 3D printer feeding module is characterized in that: Knurling is machined on the circumferences of the first feeding roller and the second feeding roller.

4. As described in claim 1, the 3D printer feeding module is characterized in that: The upper cover is also provided with a detachable transparent cover.

5. A 3D printer feeding module is characterized by comprising: A module seat with an inner cavity, a feeding mechanism arranged in the cavity of module seat and an adjusting part for adjusting the feeding spacing of feeding mechanism;
The module seat comprises a base and an upper cover detachably connected with the upper portion of base. An inward integrally-formed convex portion is arranged in the middle of upper cover and provided with a feeding channel for penetration of wires;
The feeding mechanism comprises a movable frame and two first rotating shafts which are arranged besides the feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on each second rotating shaft from bottom to top. The second drive gear is meshed with the first drive gear due to the action of compression spring. The first feeding rollers and the second feeding rollers compress on both sides of wires. Both ends of first rotating shafts and second rotating shafts are provided with bearing;
An inward integrally-formed guiding portion is arranged on the lower surface of base. A guiding groove matched with the guiding portion is formed in the bottom of movable frame. An extension plate which moves synchronously is also arranged on the movable frame. An adjusting part is embedded on one side of module seat, form a rotating structure with the base and the upper cover through a rotating shaft portion, abuts against the extension plate through an extruding portion and provided with a folding portion at the end far away from the extruding portion.

6. A 3D printer feeding module is characterized by comprising: A module seat with an inner cavity, a feeding mechanism arranged in the cavity of module seat and an adjusting part for adjusting the feeding spacing of feeding mechanism;
The module seat comprises a base and an upper cover detachably connected with the upper portion of base. An inward integrally-formed convex portion is arranged in the middle of upper cover and provided with a feeding channel for penetration of wires;
The feeding mechanism comprises a movable frame and two first rotating shafts which are arranged on both sides of a feeding channel. The first rotating shafts are arranged one behind the other in the feeding direction of feeding channel. An input gear, a first drive gear and a first feeding roller which rotate synchronously are arranged on first rotating shafts from bottom to top. The movable frame is connected with the base through a compression spring. Second rotating shafts are arranged on both ends of movable frame. A second drive gear and a second feeding roller which rotate synchronously are arranged on second rotating shafts from bottom to top. The second drive gear is meshed with the first drive gear due to the action of compression spring. The first feeding roller and the second feeding roller compress on both sides of wires. Both ends of first rotating shafts and second rotating shafts are provided with bearing.
